(19) United States
(12) Patent Application Publication
(10) Pub. No.: US 2002/0071624 A1
(43) Pub. Date: Jun. 13, 2002

(54) Fibre coupled mirror providing a wavelength independent rotation of the polarisation state of reflected light

(75) Inventors: Steven James Frisken, Randwick (AU); Dimitri M. Abakoumov, Lakemba (AU); Ralph Alexander Betts, Randwick (AU)

Correspondence Address: Ladas & Parry, 26 West 61st Street, New York, NY, 10023, US

(73) Assignee: NORTEL NETWORKS (PHOTONICS) PTY LTD

(21) Appl. No.: 09/732,243

(22) Filed: Dec. 7, 2000

(51) Int. Cl. G02B 6/27

(52) U.S. Cl. 385/11; 385/15; 359/494

(57) ABSTRACT

An optical device for producing a polarisation rotation of an optical signal, the device comprising: a birefringent material for, in use, splitting the optical signal into two orthogonal polarisation component signals; a polarisation rotating means for, in use, rotating each polarisation component signal by a predetermined amount, and wherein the device is arranged in a manner such that, in use, the two rotated polarisation component signals are being combined by way of the birefringent material for providing the predetermined polarisation rotated optical signal.

### FIELD OF THE INVENTION

The present invention relates broadly to a device for producing a 90° polarisation rotation of an optical signal, and to a method for producing a 90° polarisation-rotation of an optical signal.

### BACKGROUND OF THE INVENTION

It is often desired to provide for polarisation effect cancellation in optical components. In reflective configurations, this is typically achieved by a reflective configuration in which a 90° polarisation rotation is provided in a rotation mirror. Those designs often further involve a circulator which effectively makes the double path configuration into a transmissive device.

Faraday rotator mirrors which have previously been used for polarisation effect cancellation of optical components display, however, a strong wavelength dependence of polarisation rotation and also a maximum level of extinction of about 35 dB, meaning that polarisation effects can not be effectively cancelled over a large bandwidth or temperature range. For example, over a combined variation of 40° C. and 30 nm from a nominal temperature of Faraday rotator and central wavelength will introduce approximately a 10° error in the polarisation angle of the double pass reflected optical signal. Under those conditions, this corresponds to only a 15 dB polarisation extinction which is unacceptable and may in fact lead to a degradation of polarisation performance instead of an improvement.

Turning initially to FIG. 1, there is shown schematically an example embodiment illustrating the operation of a known Faraday rotator 1. The rotator normally consists of a lens 2, a Faraday rotator 3 providing a 45 degree rotation and a mirror 4. In FIG. 2 there is shown a series of polarisation state transitions for the arrangement of FIG. 1. Initially a basis set for the polarisation states can be chosen 5. The lens 2 has no affect on the polarisation states 6. The Faraday rotator 3 rotates the polarisation states by 45 degrees to provide polarisation states 7. Their reflection by mirror 8 provides no affect on the polarisation states 8. The Faraday rotator 9 then provides a further 45 degree rotation in the polarisation state 9 with the lens 2 having no affect on the polarisation state 10.

### SUMMARY OF THE INVENTION

It is an object of the present invention to provide a mirror with improved functionality.

In accordance with a first aspect of the present invention there is provided a device for providing a 90° polarisation rotation of an optical signal, the device comprising a birefringent material for, in use, splitting the optical signal into two orthogonal polarisation component signals, an polarisation rotating means for, in use, rotating each polarisation component signal by nominally 90°, and wherein the device is arranged in a manner such that, in use, the two rotated polarisation component signals are being combined by way of the birefringent material for providing the 90° polarisation rotated optical signal.

Accordingly, the device can rotate the optical signal by exactly 90° irrespective of wavelength or temperature dependent variations in the polarisation rotating means.

Preferably, the polarisation rotating means comprises a nominally 45° Faraday rotator and an optical circuit arranged in a manner such that, in use, the polarisation component signals are being transmitted twice through the nominally 45° Faraday rotator. The optical circuit may comprise a lens and a reflective element.

The birefringent material may comprise rutile.

The device may further comprise coupling means for, in use, coupling the optical signal into the device from an optical fibre and coupling the 90° polarisation rotated optical signal back into the optical fibre.

In accordance with a second aspect of the present invention there is provided a method for providing a 90° polarisation rotation of an optical signal, the method comprising the steps of splitting the optical signal into two orthogonal polarisation component signals utilising a birefringent material, rotating each polarisation component signal by normally 90° utilising a polarisation rotation means, and combining the two rotated polarisation component signals utilising the birefringent material.

Preferably, the step of rotating each polarisation component signal comprises utilising a nominally 45° Faraday rotator and an optical circuit arranged in a manner such that, in use, the polarisation component signals are being transmitted twice through the nominally 45° Faraday rotator. The optical circuit may comprise a lens and a reflective element.

The birefringent material may comprise rutile.

The method may further comprise the steps of coupling the optical signal into the device from an optical fibre, and coupling the rotated optical signal back into the optical fibre.

### BRIEF DESCRIPTION OF THE DRAWINGS

Preferred forms of the present invention will now be described, by way of example only, with reference to the accompanying drawings:

FIG. 1 illustrates schematically a prior art arrangement;

FIG. 2 illustrates a series of polarisation state transitions for the arrangement of FIG. 1;

FIG. 3 illustrates schematically the arrangement of the preferred embodiment;

FIG. 4 illustrates a series of polarisation state transitions for the arrangement of FIG. 3;

FIG. 5 illustrates schematically the utilisation of the preferred embodiment in a telecommunications system; and

FIG. 6 illustrates the utilisation of the preferred embodiment in conjunction with a fibre amplifier in a telecommunications system.

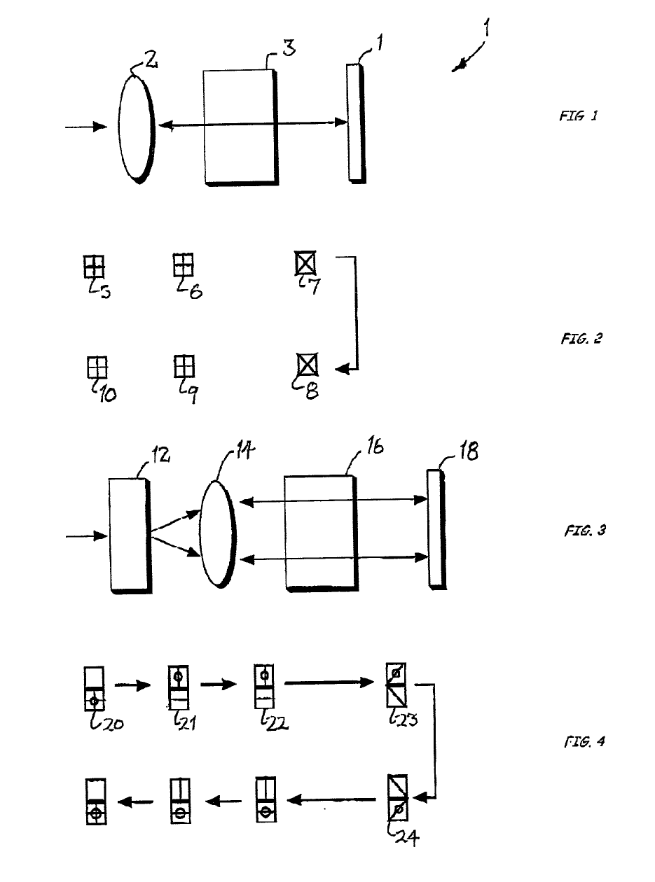

### DETAILED DESCRIPTION OF THE EMBODIMENTS

Turning now to FIG. 3 there is shown schematically the arrangement of the preferred embodiment which comprises a birefringent plate in the form of a 500 micron rutile plate 12, a lens 14, a nominally 45° Faraday rotator 16, and a mirror 18.

In FIG. 4 there is shown a corresponding series of polarisation state transitions for the system of FIG. 3. Initially, the polarisation stats are aligned 20. The rutile plate 12 separates the polarisation states 21. The lens 22 acts to focus the light in the direction of the mirror and has no affect on the polarisation states 22. The Faraday rotator 16 provides a 45 degree rotation of the polarisation states 23. Next, the mirror 18 reflects the polarisation states 24. This is followed by a subsequent non reciprocal rotation 25 by the Faraday rotator 16. The lens 14 has no affect on the polarisation state 26. This is followed by the rutile plate 12 aligning the polarisation states 27.

The birefringent plate allows only those 90 degree rotated components rotated by the Faraday mirror to be transmitted, with any error due to wavelength and temperature being lost to the system. This will introduce a small lose dependence over wavelength and temperature (up to 0.1 dB) for the components which are rejected. However, the polarisation of the recombined output signal will be rotated about the nominal 90°, since identical relative losses are being occurred for both polarisation component signals.

It was found that devices constructed in accordance with the teachings of the preferred embodiment provided a 90 degree polarisation rotation of the input polarisation state that was substantially independent of wavelength and a much higher extinction ratio of greater than 50 dB.

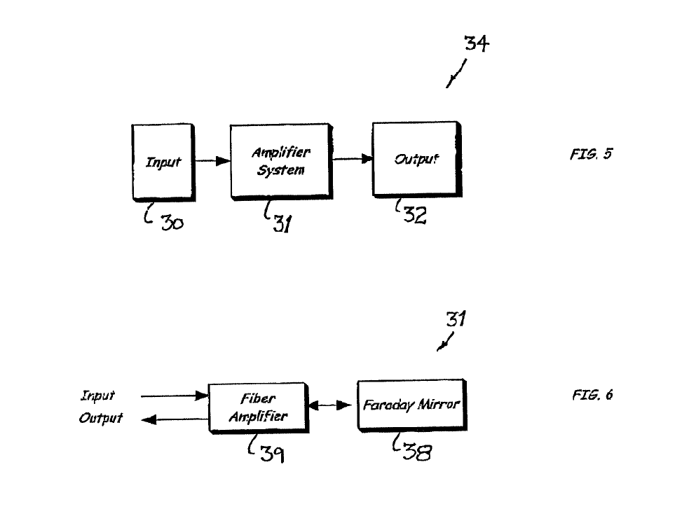

One example operational use of a Faraday mirror system in a telecommunications system will now be discussed with respect to FIG. 5 and FIG. 6. In FIG. 5 there is illustrated schematically an optical telecommunications system 34 having an input 30, an amplification section 31 and an output 32. The amplification sections includes a fibre section which amplifies the input signal in a polarisation dependant manner. As illustrated in FIG. 6, by utilisation of a Faraday mirror 38 in conjunction with the fibre amplifier 39 that allows for the Faraday mirror to be utilised to take into account the polarisation dependant nature of the fibre amplification.

It will be appreciated by a person skilled in the art that numerous variation may be made to the present invention as shown as these specific embodiments without departing from the spirit or scope of the invention as broadly described. The present embodiments are, therefore, to be considered in respects to be illustrative and not restrictive.

In the claims that follow and in the summary of the invention, except where the context requires otherwise due to express language or necessary implication the word “comprising” is used in the sense of “Including”, i.e. the features specified may be associated with further features in various embodiments of the invention.

1. An optical device for producing a polarisation rotation of an optical signal, the device comprising:
a birefringent material for, in use, splitting the optical signal into two orthogonal polarisation component signals;
a polarization rotating means for, in use, rotating each polarisation component signal by a predetermined amount, and wherein the device is arranged in a manner such that, in use, the two rotated polarisation component signals are being combined by way of the birefringent material for providing the predetermined polarisation rotated optical signal.

2. An optical device as claimed in claim 1 wherein said polarisation rotation is by 90 degrees.

3. An optical device as claimed in claim 1 wherein the polarisation rotating means comprises a nominally 45° Faraday rotator and an optical circuit arranged in a manner such that, in use, the polarisation component signals are being transmitted twice through the nominally 45° Faraday rotator.

4. An optical device as claimed in claim 3 wherein the optical circuit comprises a lens and a reflective element.

5. An optical device as claimed in claim 1 wherein the birefringent material comprises rutile.

6. An optical device as claimed in claim 1 further comprising:
coupling means for, in use, coupling the optical signal into the device from an optical fibre and coupling the 90° polarisation rotated optical signal back into the optical fibre.

7. A method for producing a predetermined polarisation rotations of an optical signal, the method comprising the steps of:
(a) splitting the optical signal into two orthogonal polarisation component signals utilising a birefringent material;
(b) rotating each polarisation component signal by nominally predetermined polarisation rotation utilising a polarisation rotation means; and
(c) combining the two rotated polarisation component signals utilising the birefringent material.

8. A method as claimed in claim 7 wherein said predetermined polarisation rotation comprises a 90 degree polarisation.

9. A method as claimed in claim 7 wherein said rotating step comprises:
rotating each polarisation component signal comprises utilising a nominally 45° Faraday rotator and an optical circuit arranged in a manner such that, in use, the polarisation component signals are being transmitted twice through the nominally 45° Faraday rotator.

10. A method as claimed in claim 9 wherein &aid optical circuit comprises a lens and a reflective element.

11. A method as claimed in claim 7 wherein the birefringent material comprises rutile.

12. A method as claimed in claim 7 wherein said method further comprises the steps of coupling the optical signal into the device from an optical fibre, and coupling the rotated optical signal back into the optical fibre.

13. A optical telecommunications system including an optical device for producing a polarisation rotation of an optical signal transmitted by said system, the device comprising:
a birefringent material for, in use, splitting the optical signal into two orthogonal polarisation component signals;
a polarisation rotating means for, in use, rotating each polarisation component signal by a predetermined amount, and wherein the device is arranged in a manner such that, in use, the two rotated polarisation component signals are being combined by way of the birefringent material for providing the predetermined polarisation rotated optical signal.
